(19) United States
(12) Patent Application Publication
(10) Pub. No.: US 2010/0128672 A1
(43) Pub. Date: May 27, 2010

(54) TRANSMITTER APPARATUS, RECEIVER APPARATUS, MOBILE STATION, AND RADIO BASE STATION

(75) Inventors: Atsushi Harada, Kanagawa (JP); Minami Ishii, Kanagawa (JP); Sadayuki Abeta, Kanagawa (JP); Anil Umesh, Kanagawa (JP)

Correspondence Address: OSHA LIANG L.L.P., TWO HOUSTON CENTER, 909 FANNIN, SUITE 3500, HOUSTON, TX, 77010, US

(73) Assignee: NTT DOCOMO, INC., Tokyo (JP)

(21) Appl. No.: 12/521,522

(22) PCT Filed: Dec. 27, 2007
(86) PCT No.: PCT/JP2007/075155

§ 371 Date: Sep. 23, 2009

(30) Foreign Application Priority Data
Dec. 28, 2006 (JP) 2006-356622

(51) Int. Cl. H04W 40/00

(52) U.S. Cl. 370/328

(57) ABSTRACT

A transmitter apparatus (10) includes: an MAC-PDU generator section (11) configured to generate an MAC-PDU by multiplexing one or more variable-length information elements each being any one of an MAC-SDU received from an RLC layer, control information, and padding information; and an MAC-PDU transmitter section (13) configured to transmit the generated MAC-PDU. The MAC-PDU generator section (13) is configured to add an MAC header including LI indicating sizes of a plurality of information elements, when the plurality of information elements is multiplexed into the MAC-PDU, and the number of pieces of the LI included in the MAC header is one number smaller than the number of the information elements being multiplexed.

### TECHNICAL FIELD

The present invention relates to a transmitter apparatus, a receiver apparatus, a mobile station, and a radio base station.

### BACKGROUND ART

As shown in FIG. 1, a mobile communication system standardized by the 3GPP (3rd Generation Partnership Project) is configured as follows. Specifically, a radio base station NodeB (transmitter apparatus) is configured to transmit a DCCH (Dedicated Control Channel), a DTCH (Dedicated Traffic Channel), a CCCH (Common Control Channel) and the like, to a mobile station UE (receiver apparatus) in downlink.

On the other hand, in uplink, the mobile station UE (transmitter apparatus) is configured to transmit a DCCH, a DTCH, a CCCH and the like, to the base station NodeB (receiver apparatus).

Moreover, as a logical channel for MBMS (Multimedia Broadcast and Multicast Service) standardized by the 3GPP, the radio base station NodeB (transmitter apparatus) is configured to transmit an MTCH (MBMS Traffic Channel) and an MCCH (MBMS Control Channel) to the mobile station UE (receiver apparatus) in downlink.

In addition, in downlink, as a physical channel for the HSDPA (High Speed Downlink Packet Access) that is the downlink high speed packet communication standard defined by the 3GPP, the radio base station NodeB (transmitter apparatus) is configured to transmit an HS-SCCH (High Speed Shared Control Channel), an HS-PDSCH (High Speed Physical Downlink Shared Channel) and the like, to the mobile station UE (receiver apparatus).

Additionally, in the HSPDA, the radio base station NodeB (transmitter apparatus) is configured to generate an MAC-hs PDU (Protocol Data Units) in the MAC-hs layer by multiplexing MAC-d PDUs received from the MAC-d layer, and to transmit the generated MAC-hs PDU by using the HS-DSCH (High Speed Downlink Shared Channel) associated with the HS-PDSCH.

Here, the MAC-d PDUs multiplexed into the MAC-hs PDU are in a fixed size for each MAC-d flow. As shown in FIG. 12, an MAC header is added to the MAC-hs PDU in the MAC-hs layer of the radio base station NodeB (transmitter apparatus), the MAC header including an “SID (Size Index Identifier)” indicative of the size of an MAC-d PDU and “N (Number of MAC-d PDUs)” indicative of the number of the MAC-d PDUs for each MAC-d flow.

However, unlike the HSDPA, high-speed packet communications such as LTE (Long Term Evaluation) are characterized in that the size of an MAC-SDU multiplexed into an MAC-PDU is variable, and that the size of the MAC-PDU transmittable per unit time is large. Accordingly, there is an increase in the number of bits necessary for “LI (Length Indicator)” indicating the sizes of respective MAC-SDUs, leading to a problem that overhead in header information increases as the number of multiplexed MAC-SDUs increases.

Non-patent Document 1: 3GPP TS 25.321 v7.0.0

### DISCLOSURE OF THE INVENTION

The present invention has been made in consideration of the above problem, and has an objective to provide a transmitter apparatus and a receiver apparatus that are capable of mitigating an overhead increase caused by information indicating the size of a data unit being multiplexed.

A first aspect of the present invention is summarized as a transmitter apparatus including: a first data unit generator section configured to generate a first data unit in a first layer by using one or more variable-length information elements each being any one of a higher layer data unit received from a layer higher than the first layer, control information, and padding information; and a first data unit transmitter section configured to transmit the generated first data unit, wherein the first data unit generator section is configured to add header information, when a plurality of information elements is multiplexed into the first data unit, the header information including information element size information indicating sizes of the information elements being multiplexed, and the number of pieces of the information element size information included in the header information is one number smaller than the number of the information elements being multiplexed.

In the first aspect, the first layer can be an MAC layer, the layer higher than the first layer can be an RLC layer, the higher-layer data unit can be an MAC-SDU, the first data unit can be an MAC-PDU, the header information can be an MAC header, and the first data unit generator section can be configured to insert the information element size information into the MAC header when more than one MAC-SDU is multiplexed, the number of pieces of the information element size information being one number smaller than the number of the MAC-SDUs being multiplexed.

A second aspect of the present invention is summarized as a transmitter apparatus including: a first data unit generator section configured to generate a first data unit in a first layer by using one or more variable-length information elements each being any one of a higher-layer data unit received from a layer higher than the first layer, control information, and padding information; and a first-data-unit transmitter section configured to transmit the generated first data unit, wherein the first data unit generator section is configured not to insert the information element size information into the header information when only one information element is multiplexed into the first data unit.

A third aspect of the present invention is summarized as a transmitter apparatus including: a first data unit generator section configured to generate a first data unit in a first layer by using one or more variable-length information elements each being any one of a higher-layer data unit received from a layer higher than the first layer, control information, and padding information; and a first-data-unit transmitter section configured to transmit the generated first data unit, wherein the first data unit generator section is configured not to insert the information element size information into the header information when one piece of control information and one piece of padding information only are multiplexed into the first data unit.

A fourth aspect of the present invention is summarized as a receiver apparatus including: a first-data-unit size information acquirer section configured to acquire first-data-unit size information from a layer lower than a first layer, the first-data-unit size information indicating a size of a first data unit; a header information analyzer section configured to detect a size of an information element multiplexed into the first data unit, based on information element size information included in the header information in the first data unit received in the first layer and the acquired first-data-unit size information; and an extractor section configured to extract the information element from the first data unit, based on the detected size of the information element, wherein the information element size information indicates the size of the information element being any one of a higher-layer data unit, control information, and padding information, and the number of pieces of the information element size information included in the header information is one number smaller than the number of the information elements multiplexed into the first data unit.

A fifth aspect of the present invention is summarized as a receiver apparatus including: a first-data-unit size information acquirer section configured to acquire first-data-unit-size information from a layer lower than a first layer, the first-data-unit size information indicating a size of a first data unit; a header information analyzer section configured to detect a size of one higher-layer data unit multiplexed into the first data unit received in the first layer based on the size of the first data unit indicated by the acquired first-data-unit size information and a size of header information in the first data unit, when the header information includes no information element size information; and an extractor section configured to extract the higher-layer data unit from the first data unit, based on the detected size of the higher-layer data unit, wherein the information element size information indicates the size of the information element being any one of a higher-layer data unit, control information, and padding information, and the number of pieces of the information element size information included in the header information is one number smaller than the number of the information elements multiplexed into the first data unit.

A sixth aspect of the present invention is summarized as a receiver apparatus including: a first-data-unit size information acquirer section configured to acquire first-data-unit-size information from a layer lower than a first layer, the first-data-unit size information indicating a size of a first data unit; a header information analyzer section configured to detect at least one of a size of one piece of control information and a size of one piece of padding information based on the size of the first data unit indicated by the acquired first-data-unit size information and a size of header information in the first data unit received in the first layer, the control information and the padding information being multiplexed into the first data unit, when the header information includes no information element size information; and an extractor section configured to extract the control information from the first data unit, based on the detected size, wherein the information element size information indicates the size of the information element being any one of a higher-layer data unit, control information, and padding information, and the number of pieces of the information element size information included in the header information is one number smaller than the number of the information elements multiplexed into the first data unit.

A seventh aspect of the present invention is summarized as a mobile station including: a first data unit generator section configured to generate a first data unit in a first layer by using one or more variable-length information elements each being any one of a higher layer data unit received from a layer higher than the first layer, control information, and padding information; and a first data unit transmitter section configured to transmit the generated first data unit, wherein

the first data unit generator section is configured to add header information, when a plurality of information elements is multiplexed into the first data unit, the header information including information element size information indicating sizes of the information elements being multiplexed, and the number of pieces of the information element size information included in the header information is one number smaller than the number of the information elements being multiplexed.

An eighth aspect of the present invention is summarized as a mobile station including: a first data unit generator section configured to generate a first data unit in a first layer by using one or more variable-length information elements each being any one of a higher-layer data unit received from a layer higher than the first layer, control information, and padding information; and a first-data-unit transmitter section configured to transmit the generated first data unit, wherein the first data unit generator section is configured not to insert the information element size information into the header information when only one information element is multiplexed into the first data unit.

A ninth aspect of the present invention is summarized as a mobile station including: a first data unit generator section configured to generate a first data unit in a first layer by using one or more variable-length information elements each being any one of a higher-layer data unit received from a layer higher than the first layer, control information, and padding information; and a first-data-unit transmitter section configured to transmit the generated first data unit, wherein the first data unit generator section is configured not to insert the information element size information into the header information when one piece of control information and one piece of padding information only are multiplexed into the first data unit.

A tenth aspect of the present invention is summarized as a radio base station including: a first data unit generator section configured to generate a first data unit in a first layer by using one or more variable-length information elements each being any one of a higher layer data unit received from a layer higher than the first layer, control information, and padding information; and a first data unit transmitter section configured to transmit the generated first data unit, wherein the first data unit generator section is configured to add header information, when a plurality of information elements is multiplexed into the first data unit, the header information including information element size information indicating sizes of the information elements being multiplexed, and the number of pieces of the information element size information included in the header information is one number smaller than the number of the information elements being multiplexed.

An eleventh aspect of the present invention is summarized as a radio base station including: a first data unit generator section configured to generate a first data unit in a first layer by using one or more variable-length information elements each being any one of a higher-layer data unit received from a layer higher than the first layer, control information, and padding information; and a first-data-unit transmitter section configured to transmit the generated first data unit, wherein the first data unit generator section is configured not to insert the information element size information into the header information when only one information element is multiplexed into the first data unit.

A twelfth aspect of the present invention is summarized as a radio base station including: a first data unit generator section configured to generate a first data unit in a first layer by using one or more variable-length information elements each being any one of a higher-layer data unit received from a layer higher than the first layer, control information, and padding information; and a first-data-unit transmitter section configured to transmit the generated first data unit, wherein the first data unit generator section is configured not to insert the information element size information into the header information when one piece of control information and one piece of padding information only are multiplexed into the first data unit.

A thirteenth aspect of the present invention is summarized as a mobile station including: a first-data-unit size information acquirer section configured to acquire first-data-unit size information from a layer lower than a first layer, the first-data-unit size information indicating a size of a first data unit; a header information analyzer section configured to detect a size of an information element multiplexed into the first data unit, based on information element size information included in the header information in the first data unit received in the first layer and the acquired first-data-unit size information; and an extractor section configured to extract the information element from the first data unit, based on the detected size of the information element, wherein the information element size information indicates the size of the information element being any one of a higher-layer data unit, control information, and padding information, and the number of pieces of the information element size information included in the header information is one number smaller than the number of the information elements multiplexed into the first data unit.

A fourteenth aspect of the present invention is summarized as a mobile station including: a first-data-unit size information acquirer section configured to acquire first-data-unit-size information from a layer lower than a first layer, the first-data-unit size information indicating a size of a first data unit; a header information analyzer section configured to detect a size of one higher-layer data unit multiplexed into the first data unit received in the first layer based on the size of the first data unit indicated by the acquired first-data-unit size information and a size of header information in the first data unit, when the header information includes no information element size information; and an extractor section configured to extract the higher-layer data unit from the first data unit, based on the detected size of the higher-layer data unit, wherein the information element size information indicates the size of the information element being any one of a higher-layer data unit, control information, and padding information, and the number of pieces of the information element size information included in the header information is one number smaller than the number of the information elements multiplexed into the first data unit.

A fifteenth aspect of the present invention is summarized as a mobile station including: a first-data-unit size information acquirer section configured to acquire first-data-unit-size information from a layer lower than a first layer, the first-data-unit size information indicating a size of a first data unit; a header information analyzer section configured to detect at least one of a size of one piece of control information and a size of one piece of padding information based on the size of the first data unit indicated by the acquired first-data-unit size information and a size of header information in the first data unit received in the first layer, the control information and the padding information being multiplexed into the first data unit, when the header information includes no information element size information; and an extractor section configured to extract the control information from the first data unit, based on the detected size, wherein the information element size information indicates the size of the information element being any one of a higher-layer data unit, control information, and padding information, and the number of pieces of the information element size information included in the header information is one number smaller than the number of the information elements multiplexed into the first data unit.

A sixteenth aspect of the present invention is summarized as a radio base station including: a first-data-unit size information acquirer section configured to acquire first-data-unit size information from a layer lower than a first layer, the first-data-unit size information indicating a size of a first data unit; a header information analyzer section configured to detect a size of an information element multiplexed into the first data unit, based on information element size information included in the header information in the first data unit received in the first layer and the acquired first-data-unit size information; and an extractor section configured to extract the information element from the first data unit, based on the detected size of the information element, wherein the information element size information indicates the size of the information element being any one of a higher-layer data unit, control information, and padding information, and the number of pieces of the information element size information included in the header information is one number smaller than the number of the information elements multiplexed into the first data unit.

A seventeenth aspect of the present invention is summarized as a radio base station including: a first-data-unit size information acquirer section configured to acquire first-data-unit-size information from a layer lower than a first layer, the first-data-unit size information indicating a size of a first data unit; a header information analyzer section configured to detect a size of one higher-layer data unit multiplexed into the first data unit received in the first layer based on the size of the first data unit indicated by the acquired first-data-unit size information and a size of header information in the first data unit, when the header information includes no information element size information; and an extractor section configured to extract the higher-layer data unit from the first data unit, based on the detected size of the higher-layer data unit, wherein the information element size information indicates the size of the information element being any one of a higher-layer data unit, control information, and padding information, and the number of pieces of the information element size information included in the header information is one number smaller than the number of the information elements multiplexed into the first data unit.

An eighteenth aspect of the present invention is summarized as a radio base station including: a first-data-unit size information acquirer section configured to acquire first-data-unit-size information from a layer lower than a first layer, the first-data-unit size information indicating a size of a first data unit; a header information analyzer section configured to detect at least one of a size of one piece of control information and a size of one piece of padding information based on the size of the first data unit indicated by the acquired first-data-unit size information and a size of header information in the first data unit received in the first layer, the control information and the padding information being multiplexed into the first data unit, when the header information includes no information element size information; and an extractor section configured to extract the control information from the first data unit, based on the detected size, wherein the information element size information indicates the size of the information element being any one of a higher-layer data unit, control information, and padding information, and the number of pieces of the information element size information included in the header information is one number smaller than the number of the information elements multiplexed into the first data unit.

### BRIEF DESCRIPTION OF THE DRAWINGS

FIG. 1 is an overall configuration diagram of a mobile communication system according to a first embodiment of the present invention.

FIG. 2 is a functional block diagram of a transmitter apparatus according to the first embodiment of the present invention.

FIG. 3 is a diagram showing a protocol stack in the mobile communication system according to the first embodiment of the present invention.

FIG. 4 is a diagram showing an example of a format of an MAC-PDU transmitted by a transmitter apparatus according to the first embodiment of the present invention.

FIG. 5 is a diagram showing an example of a format of an MAC-PDU transmitted by a transmitter apparatus according to the first embodiment of the present invention.

FIG. 6 is a diagram showing an example of a format of an MAC-PDU transmitted by the transmitter apparatus according to the first embodiment of the present invention.

FIG. 7 is a diagram showing an example of a format of an MAC-PDU transmitted by the transmitter apparatus according to the first embodiment of the present invention.

FIG. 8 is a diagram showing an example of a format of an MAC-PDU transmitted by the transmitter apparatus according to the first embodiment of the present invention.

FIG. 9 is a functional block diagram of a receiver apparatus according to the first embodiment of the present invention.

FIG. 10 is a flowchart showing an operation of the transmitter apparatus according to the first embodiment of the present invention.

FIG. 11 is a flowchart showing an operation of the receiver apparatus according to the first embodiment of the present invention.

FIG. 12 is a diagram showing an example of a format of an MAC-hs PDU used in HSDPA.

### BEST MODE FOR CARRYING OUT THE INVENTION

### Configuration of Mobile Communication System According to First Embodiment of Present Invention

### Configuration of Mobile Communication System According to First Embodiment of the Present Invention

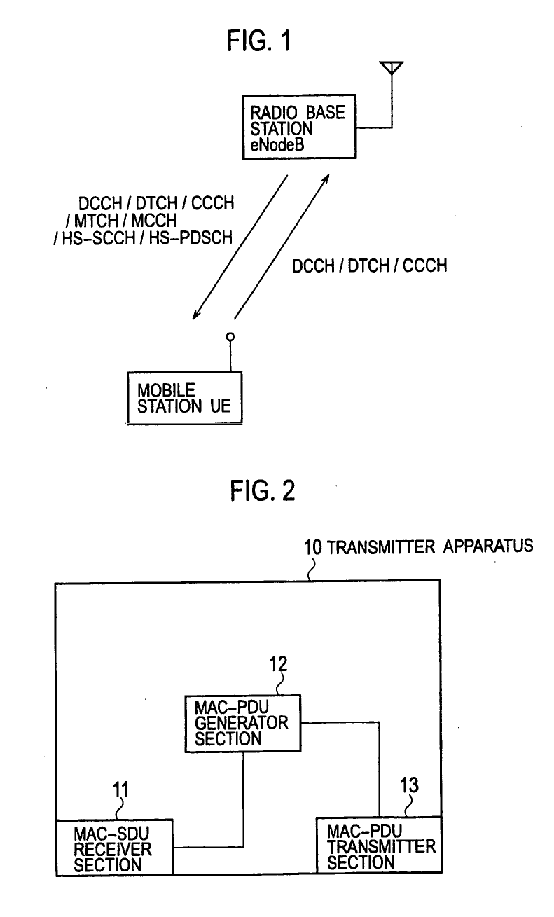

With reference to FIGS. 1 to 9, descriptions will be given of a configuration of a mobile communication system including a transmitter 10 and a receiver 30 according to a first embodiment of the present invention. The configuration of the mobile communication system according to the present embodiment is one standardized under LTE.

Here, a radio base station eNodeB may be the transmitter apparatus 10 according to the present embodiment, and a mobile station UE may be the receiver apparatus 30 according to the present embodiment. Instead, a radio base station eNodeB may be the receiver apparatus 30 according to the present embodiment, and a mobile station UE may be the transmitter apparatus 10 according to the present embodiment.

As shown in FIG. 2, the transmitter apparatus 10 includes an MAC-SDU (Service Data Unit) receiver section 11, an MAC-PDU generator section 12 and an MAC-PDU transmitter section 13, which serve as an MAC (Media Access Control) layer (first layer) function.

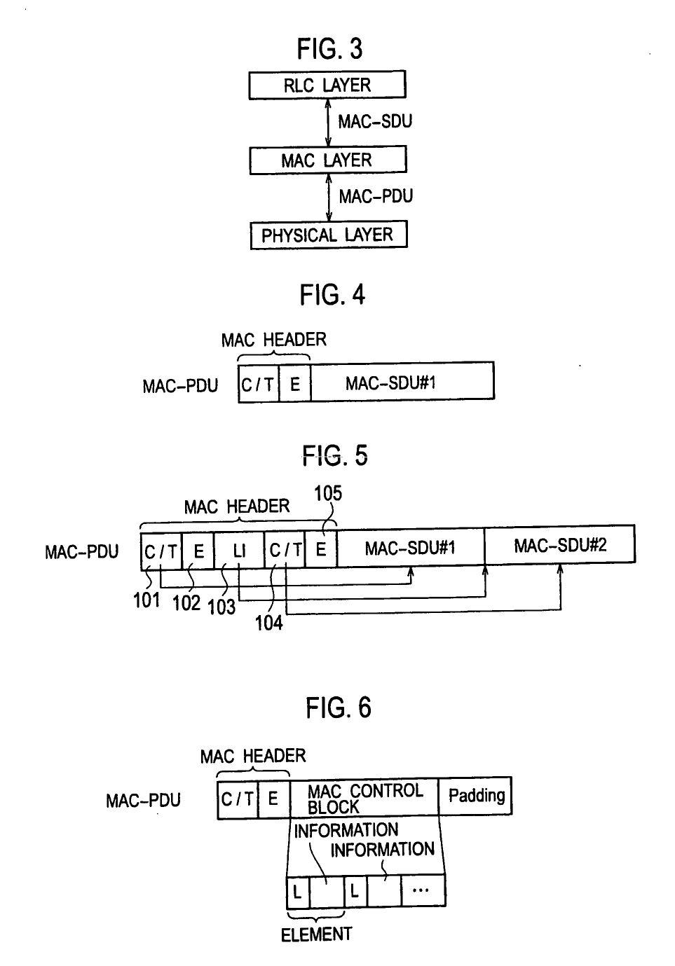

The MAC-SDU receiver section 11 is configured to receive an MAC-SDU (a higher layer data unit) from an RLC (Radio Link Control) layer (a layer higher than an MAC layer) (see FIG. 3).

The MAC-PDU generator section 12 is configured to generate an MAC-PDU by multiplexing an information element which is any of the MAC-SDU received from the RLC layer, an MAC control block (control information), and a Padding (padding information).

The MAC-PDU generator section 12 is configured to add an MAC header (header information) including “LI (information element size information)” when two or more information elements are multiplexed into the MAC-PDU (see FIGS. 5 to 8). The “LI” indicates the sizes of the two or more information elements.

As shown in FIGS. 4 to 8, the number of “LIs” included in the header information is one number smaller than the number of multiplexed information elements. Note that each of the MAC-SDU, the MAC control block, and the Padding is variable.

As shown in FIG. 4 for example, the MAC-PDU generator section 12 is configured not to insert the “LI” into the MAC header when only one MAC-SDU #1 is multiplexed into the MAC-PDU.

In the MAC-PCU format example shown in FIG. 4, the MAC header includes a set composed of “C/T” and “E”.

Here, “C/T” is information identifying the logical channel for an MAC-SDU, an MAC control block, and a Padding, which are multiplexed into the MAC-PDU.

For example, when “E” is “0”, the “E” indicates that the “E” is positioned at the end of the MAC header, and is followed by any one of the MAC-SDU, the MAC control block and the Padding. On the other hand, when “E” is “1”, the “E” indicates that the “E” is not positioned at the end of the MAC header, but is followed by another set composed of “LI”, “C/T” and “E”.

As shown in FIG. 5, the MAC-PDU generator section 12 is configured to insert one “LI” into the MAC header when two MAC-SDUs (an MAC-SDU #1 and an MAC-SDU #2) are multiplexed into the MAC-PDU.

In the MAC-PDU format example shown in FIG. 5, the MAC header includes a set composed of “C/T” 101 and “E” 102 and a set composed of “LI” 103, “C/T” 104, and “E” 105.

Here, “C/T” 101 is information identifying the logical channel for the MAC-SDU #1 multiplexed into the MAC-PDU, and “E” 102 indicates that “E” 102 is not positioned at the end of the MAC header.

“LI” 103 is information indicating the size of either the MAC-SDU #1 or the MAC-SDU #2. Moreover, “C/T” 104 is information identifying the logical channel for the MAC-SDU #2 multiplexed into the MAC-PDU, and “E” 102 indicates that “E” 102 is positioned at the end of the MAC header.

As shown in FIG. 6, the MAC-PDU generator section 12 is configured not to insert the “LI” into the MAC header when only an MAC control block and a Padding are multiplexed into the MAC-PDU (in other words, when the MAC-PDU in not multiplexed).

In the MAC-PCU format example shown in FIG. 6, the MAC header includes a set composed of “C/T” and “E”.

As shown in FIG. 6, an MAC control block consists of multiple elements each having information and “L” indicating the size of the information. Accordingly, the size of the MAC control block can be identified without “LI”.

Here, “C/T” is information indentifying the Padding multiplexed into the MAC-PDU, and “E” indicates that the “E” is positioned at the end of the MAC header.

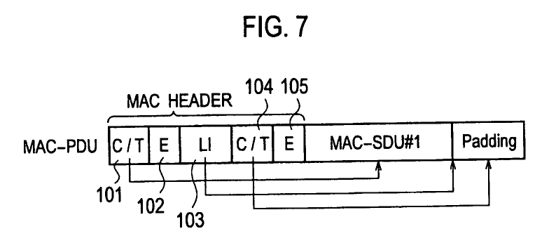

As shown in FIG. 7, the MAC-PDU generator section 12 is configured to insert one “LI” into the MAC header when an MAC-SDU #1 and a Padding are multiplexed into the MAC-PDU.

In the MAC-PCU format example shown in FIG. 7, the MAC header includes a set composed of “C/T” 101 and “E” 102 and a set composed of “LI” 103, “C/T” 104, and “E” 105.

Here, “C/T” 101 is information identifying the logical channel for the MAC-SDU #1 multiplexed into the MAC-PDU, and “E” 102 indicates that “E” 102 is not positioned at the end of the MAC header.

“LI” 103 is information indicating the size of either the MAC-SDU #1 or Padding. “C/T” 104 is information identifying the Padding multiplexed into the MAC-PDU. “E” 105 indicates that “E” 105 is positioned at the end of the MAC header.

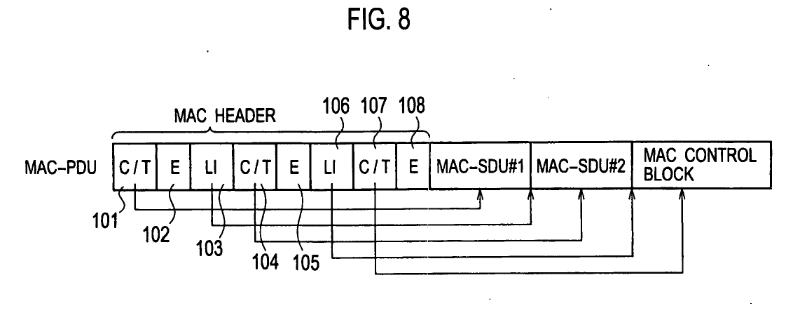

As shown in FIG. 8, the MAC-PDU generator section 12 is configured to insert two “LIs” into the MAC header when a first MAC-SDU #1, a second MAC-SDU #2, and an MAC control block are multiplexed into the MAC-PDU.

In the MAC-PCU format example shown in FIG. 8, the MAC header includes a set composed of “C/T” 101 and “E” 102, “LI” 103, “C/T” 104, and “E” 105, and a set composed of “LI” 106, “C/T” 107, and “E” 108.

Here, “C/T” 101 is information identifying the logical channel for the MAC-SDU #1 multiplexed into the MAC-PDU, and “E” 102 indicates that “E” 102 is not positioned at the end of the MAC header.

“LI” 103 is information indicating the size of the MAC-SDU #1. “C/T” 104 is information identifying the logical channel for the MAC-SDU #2 multiplexed into the MAC-PDU. “E” 105 indicates that “E” 105 is not positioned at the end of the MAC header.

“LI” 106 is information indicating the size of the MAC-SDU #2. “C/T” 107 is information identifying the MAC control block multiplexed into the MAC-PDU. “E” 108 indicates that “E” 108 is positioned at the end of the MAC header.

The MAC-PDU transmitter section 13 is configured to transmit the MAC-PDU generated by the MAC-PDU generator section 12 to the physical layer, as a single transport block.

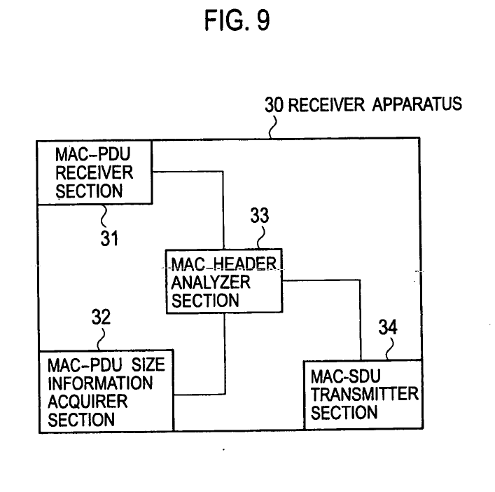

As shown in FIG. 9, as MAC layer functions, the receiver apparatus 30 includes an MAC-PDU receiver section 31, an MAC-PDU size information acquirer section 32, an MAC header analyzer section 33, and an MAC-SDU transmitter section 34.

The MAC-PDU receiver section 31 is configured to receive the MAC-PDU, transmitted by the transmitter apparatus 10, via the physical layer (see FIG. 3).

The MAC-PDU size information acquirer section 32 is configured to acquire MAC-PDU size information from the physical layer (layer lower than the MAC layer). The MAC-PDU size information indicates the size of the MAC-PDU.

Specifically, the physical layer is configured to notify, to the MAC-PDU size information acquirer section 32, a transport block size by using an L1/L2 control channel (MAC-PDU size information), the transport block size being equivalent to the size of the MAC-PDU.

The MAC header analyzer section 33 is configured to detect the size of an information element (an MAC-SDU, an MAC control block, or a Padding) multiplexed into the MAC-PDU, based on “LI (information element size information)” included in the MAC header of the MAC-PDU received in the MAC layer and the MAC-PDU size information acquired by the MAC-PDU size information acquirer section 32.

Here, when the MAC header of the MAC-PDU received by the MAC-PDU receiver section 31 includes no “LI”, the MAC header analyzer section 33 can detect the size of the information element (an MAC-PDU, an MAC control block, or a Padding) multiplexed into the MAC-PDU, based on the size of the MAC-PDU indicated by the MAC-PDU size information acquired by the MAC-PDU size information acquirer section 32 and the size of the MAC header.

In this case, specifically, the MAC header analyzer section 33 obtains the size of the information element multiplexed into the MAC-PDU by subtracting the size of the MAC header from the size of the MAC-PDU.

In the example in FIG. 4, based on “C/T”, the MAC header analyzer section 33 recognizes that an MAC-SDU #1 is the information element multiplexed into the MAC-PDU. Then, the MAC header analyzer section 33 recognizes that a value obtained by subtracting the size of the MAC header from the size of the MAC-PDU is the size of the MAC-SDU #1 multiplexed into the MAC-PDU.

Note that, as to an MAC control block consisting of multiple elements each having “L” and “information”, the MAC header analyzer section 33 can recognize, without “C/T”, that the MAC control block is multiplexed into the MAC-PDU (and the size of the MAC control block). Accordingly, in the example in FIG. 6, based on “C/T”, the MAC header analyzer section 33 recognizes that a MAC-SDU #1 is an information element multiplexed into the MAC-PDU other than the MAC control block and recognizes that a value obtained by subtracting the size of the MAC header and the size of the MAC control block from the size of the MAC-PDU is the size of the Padding multiplexed into the MAC-PDU.

The MAC-SDU transmitter section 34 is configured to extract the information element from the MAC-PDU, based on the size of the information element detected by the MAC header analyzer 33.

Moreover, the MAC-SDU transmitter section 34 is configured to transmit the extracted MAC-SDU to the RLC layer.

### Operation of Mobile Communication System According to First Embodiment of the Present Invention

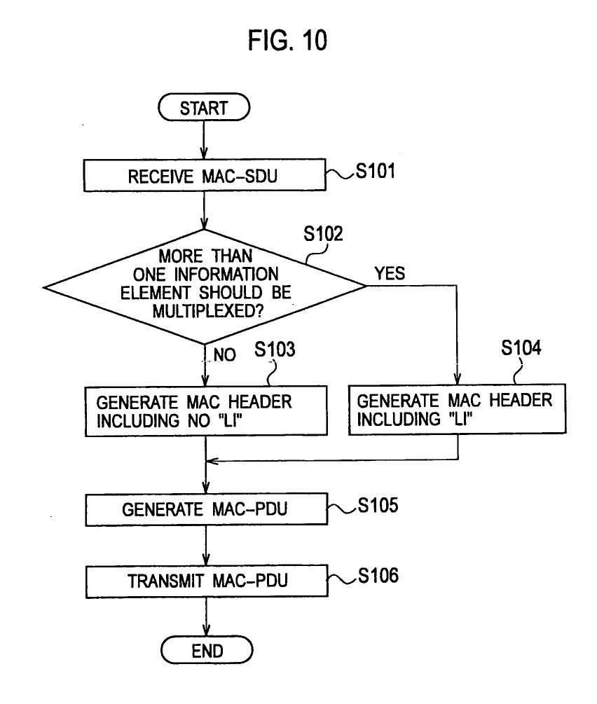

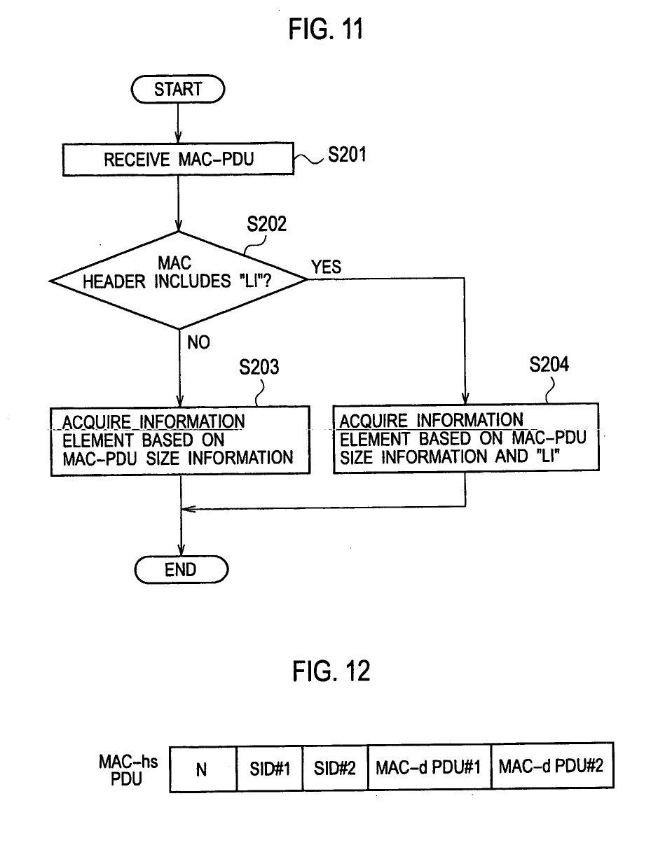

With reference to FIGS. 10 and 11, description will be given of an operation of the mobile communication system according to the first embodiment of the present invention.

In the first place, an operation of the transmitter apparatus 10 according to the present embodiment will be described with reference to FIG. 10.

As shown in FIG. 10, in Step S101, an MAC-layer function of the transmitter apparatus 10 receives an MAC-SDU to be transmitted to the receiver apparatus 30, from the RLC layer of the transmitter apparatus 10.

In Step S102, the MAC-layer function of the transmitter apparatus 10 determines whether or not multiple information elements should be multiplexed into a single MAC-PDU.

When determined that multiple information elements should not be multiplexed, the MAC layer function generates an MAC header including no “LI” (see FIG. 4), in Step S103.

On the other hand, when determined that multiple information elements should be multiplexed, the MAC layer function generates an MAC header including “LI”. The number of “LI” included in the MAC header is one number smaller than the number of the multiple information elements being multiplexed (see FIGS. 5, 7, and 8), in Step S104.

Exceptionally, when multiplexing one MAC control block and one Padding into one MAC-PDU, the MAC function generates an MAC header including no “LI” (see FIG. 6).

In Step S105, the MAC layer function generates an MAC-PDU in which the generated MAC header is added. Then in Step S106, an MAC layer function transmits the generated MAC-PDU to the receiver apparatus 30 via the physical layer of the transmitter apparatus 10.

In the second place, an operation of the receiver apparatus 30 according to the present embodiment will be described with reference to FIG. 11.

As shown in FIG. 11, the MAC layer function of the receiver apparatus 30 receives the MAC-PDU transmitted by the transmitter apparatus 10, through the physical layer of the receiver apparatus 30.

In Step S202, the MAC layer function of the receiver apparatus 30 determines whether or not the MAC header added in the MAC-PDU thus received includes “LI”.

When determined that “LI” is not included, the MAC layer function of the receiver apparatus 30 identifies an information element multiplexed into the MAC-PDU in Step S203, based on “C/T” included in the MAC header. Then, the MAC layer function acquires the information element thus identified (e.g., an MAC-SDU), based on the size of the MAC-PDU included in the MAC-PDU size information notified of by the physical layer and on the size of the MAC header.

On the other hand, when determined that “LI” is included, the MAC layer function of the receiver apparatus 30 recognizes an information element multiplexed into the MAC-PDU by use of “C/T” included in the MAC header, in Step S204. Then, the MAC layer function acquires the information element thus recognized (e.g., an MAC-SDU), based on the size of the MAC-PDU included in the MAC-PDU size information notified of from the physical layer, the size of the MAC header, and “LI”.

### Operations and Effects of Mobile Communication System According to First Embodiment of the Present Invention

The mobile communication system according to the first embodiment of the present invention allows the number of “LIs” included in an MAC header to be one number smaller than the number of information elements multiplexed into an MAC-PDU. In high-speed packet communications, this can mitigate an overhead increase caused by “LI” indicating the size of an MAC-PDU after being multiplexed.

Hereinabove, the present invention has been described in detail by use of the foregoing embodiment. It is obvious, however, to those skilled in the art that the present invention should not be limited to the embodiment described in this description. The present invention is implementable as modified and improved embodiments without departing from the sprit and the scope of the present invention defined by the description of the scope of the appended claims. Therefore, the explanation of this description is intended only to explain an illustrative example of the present invention, and is not intended to impose any limitation on the present invention.

### INDUSTRIAL APPLICABILITY

As described above, the present invention can provide a transmitter and a receiver that are capable of mitigating an overhead increase caused by information indicating the size of a data unit after being multiplexed, in high-speed packet communications.

1. A transmitter apparatus comprising:
a first data unit generator section configured to generate a first data unit in a first layer by using one or more variable-length information elements each being any one of a higher layer data unit received from a layer higher than the first layer, control information, and padding information; and
a first data unit transmitter section configured to transmit the generated first data unit, wherein
the first data unit generator section is configured to add header information, when a plurality of information elements is multiplexed into the first data unit, the header information including information element size information indicting sizes of the information elements being multiplexed, and
the number of pieces of the information element size information included in the header information is one number smaller than the number of the information elements being multiplexed.

2. The transmitter apparatus according to claim 1, wherein
the first layer is an MAC layer,
the layer higher than the first layer is an RLC layer,
the higher-layer data unit is an MAC-SDU,
the first data unit is an MAC-PDU,
the header information is an MAC header, and
the first data unit generator section is configured to insert the information element size information into the MAC header when more than one MAC-SDU is multiplexed, the number of pieces of the information element size information being one number smaller than the number of the MAC-SDUs being multiplexed.

3. A transmitter apparatus comprising:
a first data unit generator section configured to generate a first data unit in a first layer by using one or more variable-length information elements each being any one of a higher-layer data unit received from a layer higher than the first layer, control information, and padding information; and
a first-data-unit transmitter section configured to transmit the generated first data unit, wherein
the first data unit generator section is configured not to insert information element size information into header information when only one information element is multiplexed into the first data unit.

4. A transmitter apparatus comprising:
a first data unit generator section configured to generate a first data unit in a first layer by using one or more variable-length information elements each being any one of a higher-layer data unit received from a layer higher than the first layer, control information, and padding information; and
a first-data-unit transmitter section configured to transmit the generated first data unit, wherein
the first data unit generator section is configured not to insert information element size information into header information when one piece of control information and one piece of padding information only are multiplexed into the first data unit.

5. A receiver apparatus comprising:
a first-data-unit size information acquirer section configured to acquire first-data-unit size information from a layer lower than a first layer, the first-data-unit size information indicating a size of a first data unit;
a header information analyzer section configured to detect a size of an information element multiplexed into the first data unit, based on information element size information included in the header information in the first data unit received in the first layer and the acquired first-data-unit size information; and
an extractor section configured to extract the information element from the first data unit, based on the detected size of the information element, wherein
the information element size information indicates the size of the information element being any one of a higher-layer data unit, control information, and padding information, and
the number of pieces of the information element size information included in the header information is one number smaller than the number of the information elements multiplexed into the first data unit.

6. A receiver apparatus comprising:
a first-data-unit size information acquirer section configured to acquire first-data-unit-size information from a layer lower than a first layer, the first-data-unit size information indicating a size of a first data unit;
a header information analyzer section configured to detect a size of one higher-layer data unit multiplexed into the first data unit received in the first layer based on the size of the first data unit indicated by the acquired first-data-unit size information and a size of header information in the first data unit, when the header information includes no information element size information; and
an extractor section configured to extract the higher-layer data unit from the first data unit, based on the detected size of the higher-layer data unit, wherein
the information element size information indicates the size of the information element being any one of a higher-layer data unit, control information, and padding information, and
the number of pieces of the information element size information included in the header information is one number smaller than the number of the information elements multiplexed into the first data unit.

7. A receiver apparatus comprising:
a first-data-unit size information acquirer section configured to acquire first-data-unit-size information from a layer lower than a first layer, the first-data-unit size information indicating a size of a first data unit;
a header information analyzer section configured to detect at least one of a size of one piece of control information and a size of one piece of padding information based on the size of the first data unit indicated by the acquired first-data-unit size information and a size of header information in the first data unit received in the first layer, the control information and the padding information being multiplexed into the first data unit, when the header information includes no information element size information; and
an extractor section configured to extract the control information from the first data unit, based on the detected size, wherein
the information element size information indicates the size of the information element being any one of a higher-layer data unit, control information, and padding information, and
the number of pieces of the information element size information included in the header information is one number smaller than the number of the information elements multiplexed into the first data unit.

8. A mobile station comprising:
a first data unit generator section configured to generate a first data unit in a first layer by using one or more variable-length information elements each being any one of a higher layer data unit received from a layer higher than the first layer, control information, and padding information; and
a first data unit transmitter section configured to transmit the generated first data unit, wherein
the first data unit generator section is configured to add header information, when a plurality of information elements is multiplexed into the first data unit, the header information including information element size information indicating sizes of the information elements being multiplexed, and
the number of pieces of the information element size information included in the header information is one number smaller than the number of the information elements being multiplexed.

9. A mobile station comprising:
a first data unit generator section configured to generate a first data unit in a first layer by using one or more variable-length information elements each being any one of a higher-layer data unit received from a layer higher than the first layer, control information, and padding information; and
a first-data-unit transmitter section configured to transmit the generated first data unit, wherein
the first data unit generator section is configured not to insert information element size information into header information when only one information element is multiplexed into the first data unit.

10. A mobile station comprising:
a first data unit generator section configured to generate a first data unit in a first layer by using one or more variable-length information elements each being any one of a higher-layer data unit received from a layer higher than the first layer, control information, and padding information; and
a first-data-unit transmitter section configured to transmit the generated first data unit, wherein
the first data unit generator section is configured not to insert information element size information into header information when one piece of control information and one piece of padding information only are multiplexed into the first data unit.

11. A radio base station comprising:
a first data unit generator section configured to generate a first data unit in a first layer by using one or more variable-length information elements each being any one of a higher layer data unit received from a layer higher than the first layer, control information, and padding information; and
a first data unit transmitter section configured to transmit the generated first data unit, wherein
the first data unit generator section is configured to add header information, when a plurality of information elements is multiplexed into the first data unit, the header information including information element size information indicating sizes of the information elements being multiplexed, and
the number of pieces of the information element size information included in the header information is one number smaller than the number of the information elements being multiplexed.

12. A radio base station comprising:
a first data unit generator section configured to generate a first data unit in a first layer by using one or more variable-length information elements each being any one of a higher-layer data unit received from a layer higher than the first layer, control information, and padding information; and
a first-data-unit transmitter section configured to transmit the generated first data unit, wherein
the first data unit generator section is configured not to insert the information element size information into the header information when only one information element is multiplexed into the first data unit.

13. A radio base station comprising:
a first data unit generator section configured to generate a first data unit in a first layer by using one or more variable-length information elements each being any one of a higher-layer data unit received from a layer higher than the first layer, control information, and padding information; and
a first-data-unit transmitter section configured to transmit the generated first data unit, wherein
the first data unit generator section is configured not to insert the information element size information into the header information when one piece of control information and one piece of padding information only are multiplexed into the first data unit.

14. A mobile station comprising:
a first-data-unit size information acquirer section configured to acquire first-data-unit size information from a layer lower than a first layer, the first-data-unit size information indicating a size of a first data unit;
a header information analyzer section configured to detect a size of an information element multiplexed into the first data unit, based on information element size information included in the header information in the first data unit received in the first layer and the acquired first-data-unit size information; and
an extractor section configured to extract the information element from the first data unit, based on the detected size of the information element, wherein
the information element size information indicates the size of the information element being any one of a higher-layer data unit, control information, and padding information, and
the number of pieces of the information element size information included in the header information is one number smaller than the number of the information elements multiplexed into the first data unit.

15. A mobile station comprising:
a first-data-unit size information acquirer section configured to acquire first-data-unit-size information from a layer lower than a first layer, the first-data-unit size information indicating a size of a first data unit;
a header information analyzer section configured to detect a size of one higher-layer data unit multiplexed into the first data unit received in the first layer based on the size of the first data unit indicated by the acquired first-data-unit size information and a size of header information in the first data unit, when the header information includes no information element size information; and
an extractor section configured to extract the higher-layer data unit from the first data unit, based on the detected size of the higher-layer data unit, wherein
the information element size information indicates the size of the information element being any one of a higher-layer data unit, control information, and padding information, and
the number of pieces of the information element size information included in the header information is one number smaller than the number of the information elements multiplexed into the first data unit.

16. A mobile station comprising:
a first-data-unit size information acquirer section configured to acquire first-data-unit-size information from a layer lower than a first layer, the first-data-unit size information indicating a size of a first data unit;
a header information analyzer section configured to detect at least one of a size of one piece of control information and a size of one piece of padding information based on the size of the first data unit indicated by the acquired first-data-unit size information and a size of header information in the first data unit received in the first layer, the control information and the padding information being multiplexed into the first data unit, when the header information includes no information element size information; and
an extractor section configured to extract the control information from the first data unit, based on the detected size, wherein
the information element size information indicates the size of the information element being any one of a higher-layer data unit, control information, and padding information, and
the number of pieces of the information element size information included in the header information is one number smaller than the number of the information elements multiplexed into the first data unit.

17. A radio base station comprising:
a first-data-unit size information acquirer section configured to acquire first-data-unit size information from a layer lower than a first layer, the first-data-unit size information indicating a size of a first data unit;
a header information analyzer section configured to detect a size of an information element multiplexed into the first data unit, based on information element size information included in the header information in the first data unit received in the first layer and the acquired first-data-unit size information; and
an extractor section configured to extract the information element from the first data unit, based on the detected size of the information element, wherein
the information element size information indicates the size of the information element being any one of a higher-layer data unit, control information, and padding information, and
the number of pieces of the information element size information included in the header information is one number smaller than the number of the information elements multiplexed into the first data unit.

18. A radio base station comprising:
a first-data-unit size information acquirer section configured to acquire first-data-unit-size information from a layer lower than a first layer, the first-data-unit size information indicating a size of a first data unit;
a header information analyzer section configured to detect a size of one higher-layer data unit multiplexed into the first data unit received in the first layer based on the size of the first data unit indicated by the acquired first-data-unit size information and a size of header information in the first data unit, when the header information includes no information element size information; and
an extractor section configured to extract the higher-layer data unit from the first data unit, based on the detected size of the higher-layer data unit, wherein
the information element size information indicates the size of the information element being any one of a higher-layer data unit, control information, and padding information, and
the number of pieces of the information element size information included in the header information is one number smaller than the number of the information elements multiplexed into the first data unit.

19. A radio base station comprising:
a first-data-unit size information acquirer section configured to acquire first-data-unit-size information from a layer lower than a first layer, the first-data-unit size information indicating a size of a first data unit;
a header information analyzer section configured to detect at least one of a size of one piece of control information and a size of one piece of padding information based on the size of the first data unit indicated by the acquired first-data-unit size information and a size of header information in the first data unit received in the first layer, the control information and the padding information being multiplexed into the first data unit, when the header information includes no information element size information; and
an extractor section configured to extract the control information from the first data unit, based on the detected size, wherein
the information element size information indicates the size of the information element being any one of a higher-layer data unit, control information, and padding information, and
the number of pieces of the information element size information included in the header information is one number smaller than the number of the information elements multiplexed into the first data unit.
